(19) United States
(12) Patent Application Publication
(10) Pub. No.: US 2003/0066936 A1
(43) Pub. Date: Apr. 10, 2003

(54) Cable management system

(75) Inventors: Robert L. Beck, Zeeland, MI (US); Andrew J. Kurrasch, Saugatuck, MI (US); Thomas W. Granzow, Byron Center, MI (US); James H. Nienhuis, Hudsonville, MI (US); Glen V. Walter, Boxford, MA (US); Mehmet T. Ergelen, Newton, MA (US); Benjamin J. Beck, Boston, MA (US)

Correspondence Address: BRINKS HOFER GILSON & LIONE, P.O. BOX 10395, CHICAGO, IL, 60611, US

(73) Assignee: Herman Miller, Inc.

(21) Appl. No.: 10/251,536

(22) Filed: Sep. 20, 2002

Related U.S. Application Data
(60) Provisional application No. 60/324,733, filed on Sep. 24, 2001.

(51) Int. Cl. F16L 3/00

(52) U.S. Cl. 248/49

(57) ABSTRACT

A cable management system is provided for routing cables through an office area. The cable management system is particularly useful for open office areas to improve collaboration between office workers. The cable management system includes a top post for routing cables from a ceiling down to a connecting hub. Horizontal beams are attached to the connecting hubs, and the cables pass through the horizontal beams.

This application claims priority under 35 U.S.C. § 119(e) to provisional application number 60/324,733 by Beck et al. and entitled Cable Management System, filed Sep. 24, 2001, which is hereby incorporated by reference herein.

### BACKGROUND

The present invention relates generally to office furniture, and more particularly, to a system for managing cables in an office area.

As those in the furniture arts well know, a need exists for improved systems for managing cables in office areas. This need has arisen due to the increased number of communication cables that are now required to interconnect various electronic equipment typically used in office areas. A desire also exists for open office areas that minimize visual obstructions between individual workspaces. Generally, open office areas are usually desired by work groups that engage in a high level of collaboration between office workers.

Traditionally, office areas have been configured with a series of interconnected workspace panels that form individual workspaces for each office worker using the office area. Workspace panels typically provide a high level of privacy between individual workspaces. However, conventional workspace panels also limit the amount of collaboration possible between office workers. Workspace panels also often provide a convenient path for routing cables through the office area. Accordingly, raceways are sometimes provided through the workspace panels. Thus, cables may be routed through the raceways in the workspace panels and throughout the office area to various equipment as needed.

One problem that occurs in open office areas is the difficulty associated with routing cables through the office area in a concealed manner. Normally, in open office areas cables are routed through the floor in one of several ways. For example, cables are sometimes routed through permanent channels or passageways in the floor. This alternative is not desirable, however, because of the expenses involved with constructing the channels or passageways and because rerouting the cables at a later time is usually difficult, time-consuming and expensive. Another alternative is to use a raised flooring system. These systems are usually somewhat more flexible. However, later rerouting of the cables is typically still difficult and time-consuming after the raised flooring system is installed and desks and other equipment are arranged on the flooring system. Another disadvantage of raised flooring systems is the added expense of the flooring system and the decreased vertical space available in the office area.

Another problem associated with cable management systems is the difficulty of installing cables through narrow, enclosed routing passages which are typical in most management systems. As those in the art well know, cables usually must be pulled through the passages using a draw tool or pushed through the passages from one end. These methods can be difficult, and sometimes nearly impossible, when a passage is especially long compared to its cross-section.

Even in open work areas, dividing systems are often desirable to provide boundaries between adjacent workspaces. However, dividing systems in open work areas must be unobtrusive. In addition, dividing systems that are easily reconfigurable are preferred. A dividing system that allows the dividing boundaries to be instantly moved by hand would be especially desirable.

Another problem that is common in office areas is the accumulation of excess lengths of cables that typically occurs behind computer terminals. Usually, these excess lengths of cables are left to hang in an unsightly manner behind computer equipment. However, this leaves the office area looking disorganized and unprofessional, and the excess lengths of cables may inadvertently snag during use.

### BRIEF SUMMARY

Accordingly, a cable management system is provided for open office areas. The cable management system includes a connecting hub with a base disposed on the floor. A top post that extends up to the ceiling is attached to the connecting hub. Horizontal beams are also attached to the connecting hub and extend outward therefrom. Cables may be routed through the cable management system by passing the cables from the ceiling down through the top post and through the horizontal beams.

### BRIEF DESCRIPTION OF SEVERAL VIEW OF THE DRAWINGS

The invention, including its construction and method of operation, is illustrated more or less diagrammatically in the drawings, in which:

FIG. 1 is a perspective view of a cable management system;

FIG. 2 is a perspective view of a portion of the cable management system;

FIG. 3 is an exploded view of the portion shown in FIG. 2;

FIG. 4 is a side view of the portion shown in FIG. 2;

FIG. 4A is a cross section of a portion of FIG. 4;

FIG. 5 is a perspective view of a connecting hub, showing a connecting hub cover and a top cover removed to illustrate the interior of the connecting hub;

FIG. 6 is a perspective view of a horizontal beam;

FIG. 7 is an exploded view of the horizontal beam shown in FIG. 6; and

FIG. 8 is a perspective view of a portion of the horizontal beam and a cable management pouch, showing an excess length of cable within the pouch.

### DETAILED DESCRIPTION

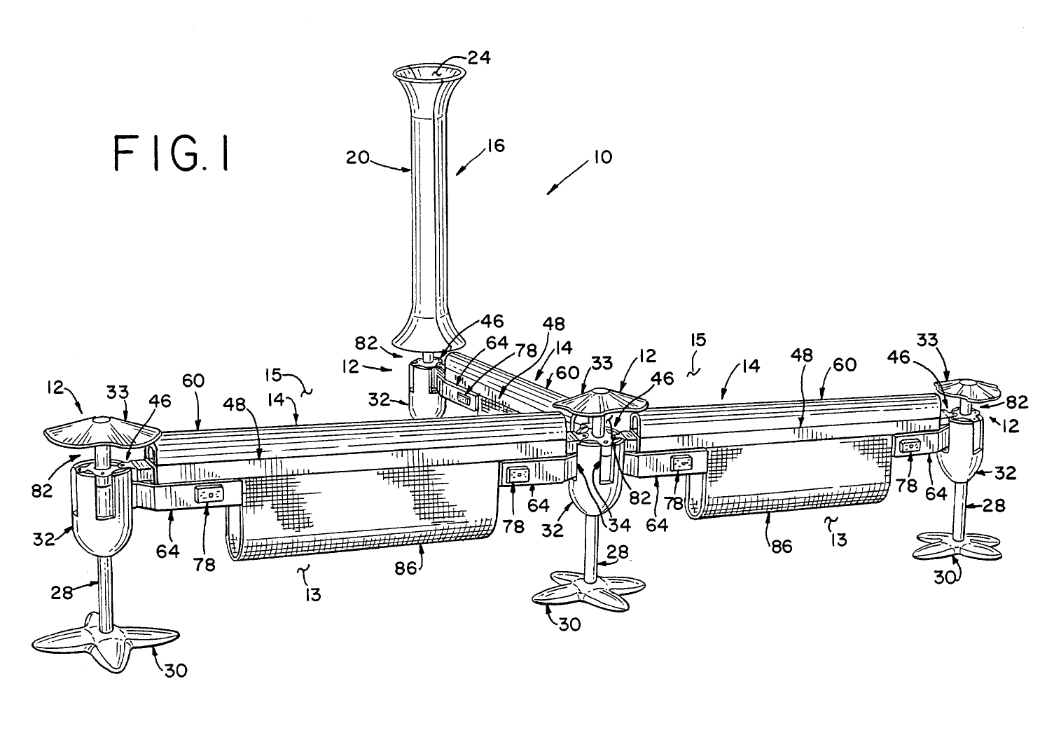

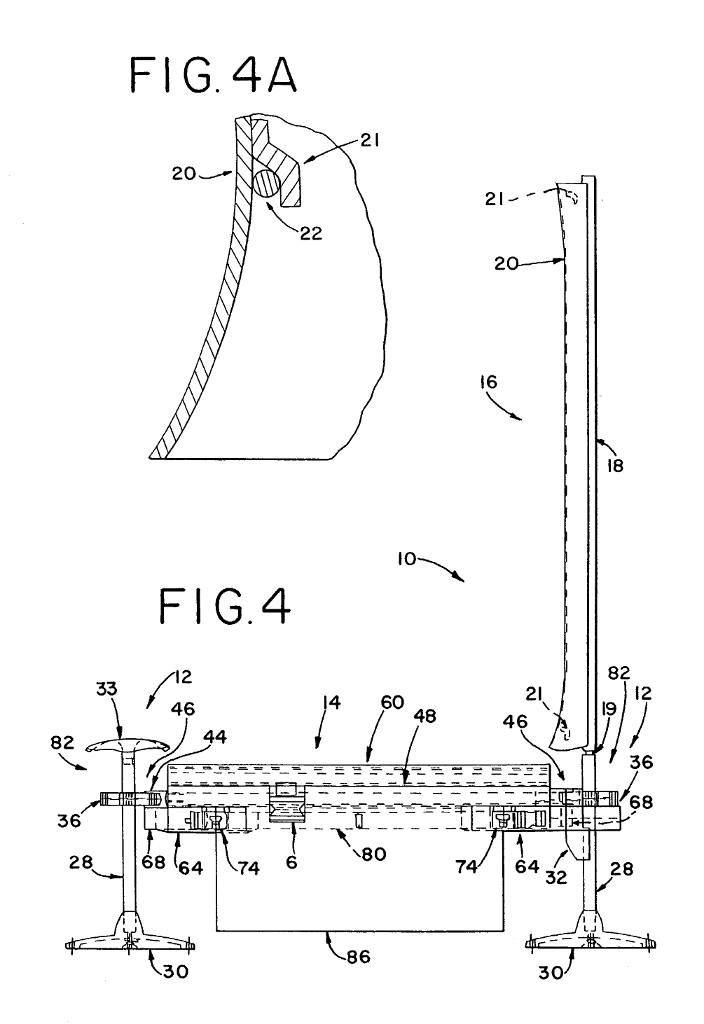

Referring now to the drawings, and particularly to FIGS. 1 through 5, a cable management system 10 for an open office area is provided. The cable management system 10 includes a number of connecting hubs 12 interconnected by horizontal beams 14. Accordingly, the connecting hubs 12 and horizontal beams 14 may be configured as a dividing system that provides boundaries around adjacent workspaces. A bottom open area 13 is thus formed between the horizontal beams 14 and the floor, and a top open area 15 is formed between the horizontal beams 14 and the ceiling. Preferably, the horizontal beams 14 are positioned about 1.5 to 3.5 feet above the floor. Cables, including communication cables 2 and electrical wires 4, are supplied to the cable management system 10 from the ceiling. The cables 2, 4 are then routed down through one or more top posts 16 which are connected to the connecting hubs 12. Next, the cables 2, 4 may be routed throughout the office area through the horizontal beams 14 and the other connecting hubs 12.

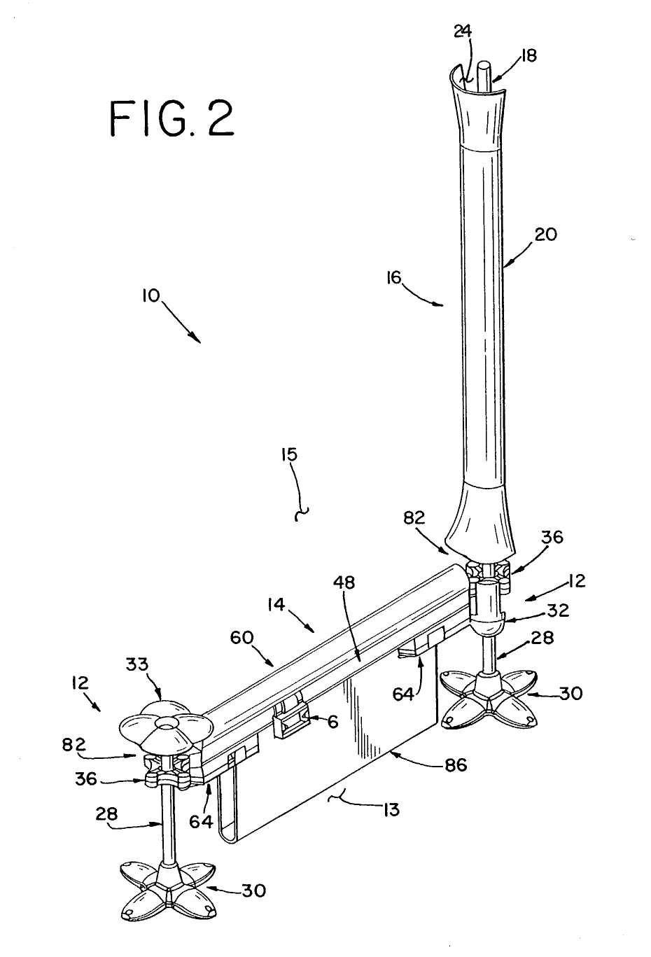

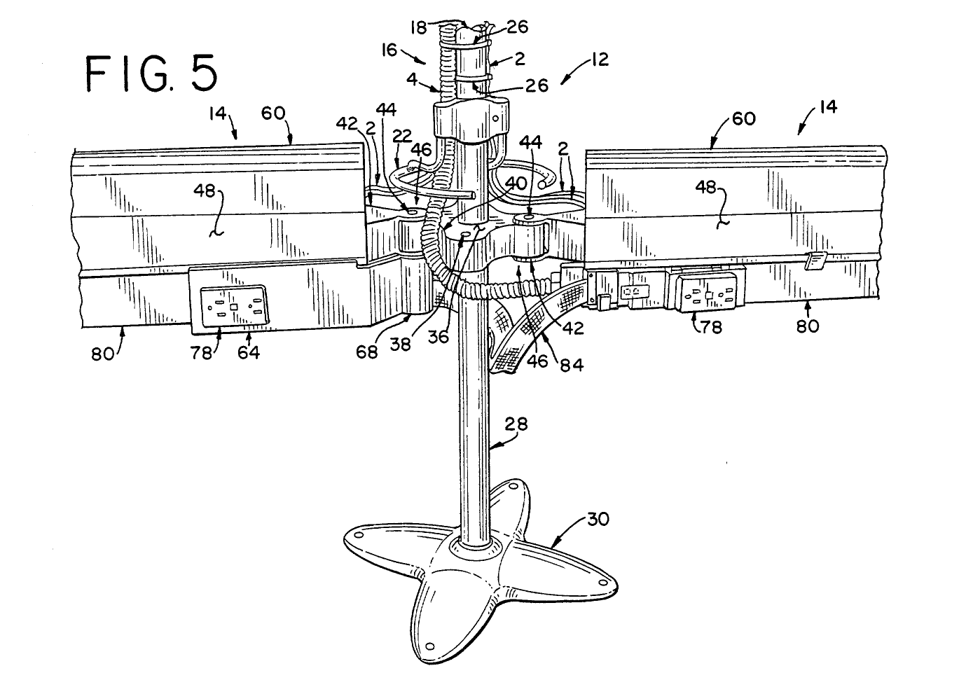

One of the top posts 16 is shown detail in FIGS. 2 through 4. The top post 16 includes a structural tube 18, or member, that extends up from a connecting hub 12 to the ceiling. The top structural tube 18 may or may not be attached to the ceiling, depending on the particular requirements of the office area. At the lower end, the top structural tube 18 is attached to a bottom structural tube 28. Preferably, the lower end of the top structural tube 18 includes a narrowed portion 19 that may be pressed into the inner diameter of the bottom structural tube 28. The top post 16 also includes a top cover 20 which may be made from a flexible plastic material. Thus, the top cover 20 may be installed and removed from the top post 16 by flexing and snapping the top cover 20 onto and off of the top structural tube 18. Lower and upper support members 22 (see FIG. 5) are also included to maintain the shape and position of the top cover 20 when installed onto the top structural tube 18. Accordingly, the support members 22 are attached to opposite ends of the top structural tube 18 and form a circular support surface that contacts the inner surface of the top cover 20. Hooks 21 are also provided along the upper interior surface of the top cover 20 in order to hang the top cover 20 from the upper support member 22.

It is now apparent that cables 2, 4 may be routed from the ceiling into the top end of the top post 16. The cables 2, 4 pass through the open cavity 24 formed between the top structural tube 18 and the top cover 20 down to the connecting hub 20. Preferably, the cables 2, 4 are secured to the top structural tube 18 with plastic ties 26. The cable management system 10 may be used to route a variety of cables 2, 4 through an office area. Thus, both communication cables 2 and electrical cables 4 may be routed from the ceiling down through the top post 16. Preferably, the electrical cables are installed within an industry standard electrical conduit 4. At the bottom of the top post 16, the cables 2, 4 pass through the connecting hub 12 to the horizontal beams 14 as described in detail below.

The interior of one of the connecting hubs 12 is shown in detail in FIG. 5. The connecting hub 12 includes a bottom structural tube 28, or member, that extends down from the connecting hub 12. At the bottom of the bottom structural tube 28 is a support base 30 that rests on the floor, thereby supporting the weight of the cable management system 10 and providing stability. The top end of the bottom structural tube 28 is attached to the connecting member 36 and the top structural tube 18. The connecting hub 12 also includes a connecting hub cover 32 that may be made from a plastic material. The connecting hub cover 32 preferably includes two separate halves that may be snapped together when installed onto the connecting hub 12 and may be snapped apart in order to remove one or both of the connecting hub cover halves 32. (In FIG. 5 the connecting hub cover halves 32 are shown removed to display the inside of the connecting hub 12.) The connecting hub covers 32 also include vertical open slots 34 to provide an opening through the connecting hub covers 32 for the pivot connections 46 described below. The connecting hubs 12 that are not attached to a top post 16 include a connecting hub top cover 33.

The connecting hub 12 includes a connecting member 36 with four connecting holes 38 equally spaced around the connecting member 36. Other configurations with more or less than four connecting holes 38 are possible however. The connecting member 36 is attached to the bottom structural tube 28 with a cross hole 29 and a pin (not indicated) through the bottom structural tube 28 and the connecting member 36. A recessed area 40 is provided between adjacent connecting holes 38. The horizontal beams 14 are attached to the connecting member 36 with clevis ends 42 that are rotably attached to the connecting holes 38 with pins 44. Therefore, up to four horizontal beams 14 may be attached to each connecting hub 12 using the pivot connections 46. Thus, in the embodiment shown, four horizontal beams 14 may extend out from one connecting hub 12 at generally right angles from each other. Other versions of the cable management system 10 with other angles between adjacent horizontal beams 14 are also possible. In the embodiment shown, less than four horizontal beams 14 may be attached to some of the connecting hubs 12 so that three, two or one horizontal beam(s) 14 extend out from the connecting hubs 12.

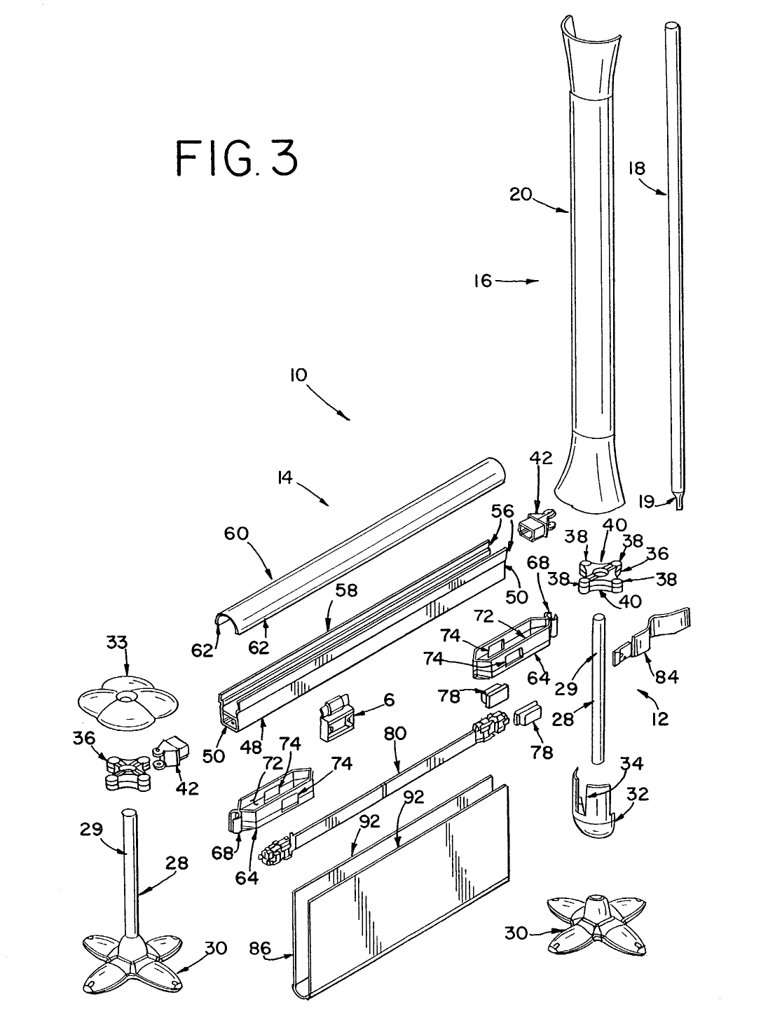

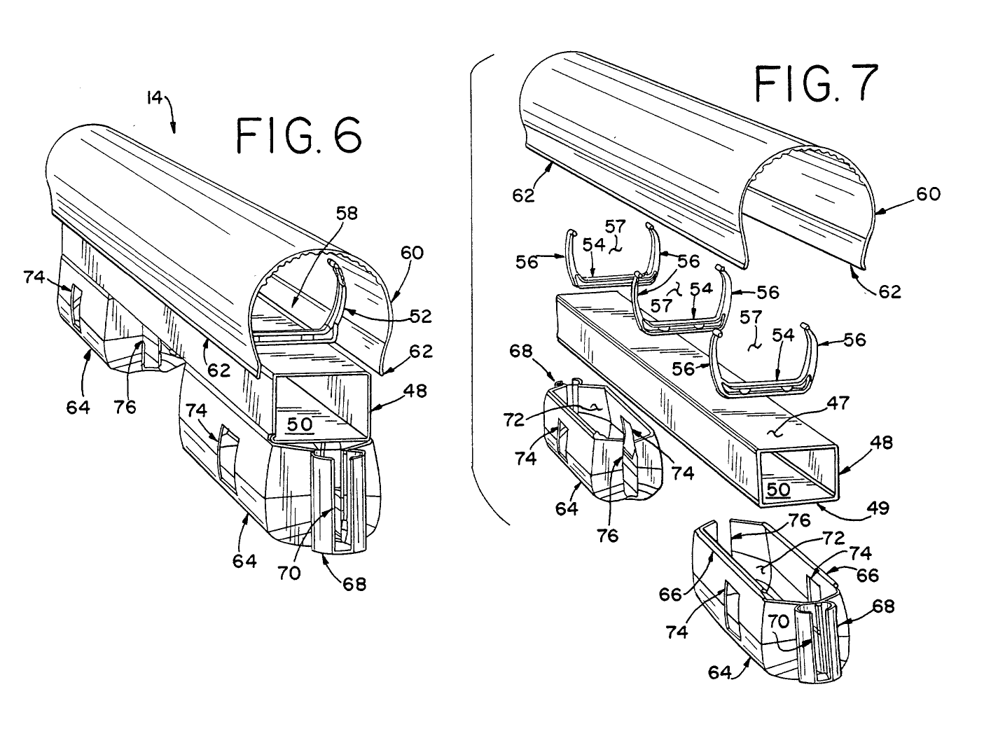

Turning now also to FIGS. 6 and 7, one of the horizontal beams 14 is shown in detail. The horizontal beam 14 includes a rectangular structural tube 48, or member, made from a steel material. One of the clevis ends 42 is attached to each end of the structural tube 48 by sliding the clevis end 42 into the open ends 50 of the tube 48 (shown in FIG. 3). The clevis ends 42 may be secured to the structural tube 48 with screws or other means.

Clips 42 are attached along the length of the structural tube 48 to the top surface 47 of the tube 48. Preferably, the clips 52 are made from a flexible plastic material. The clips 52 may be secured to the structural tube 48 with screws that extend through the base section 54 of the clips 52 and the top surface 47 of the tube 48 or may be secured by other means. The clips 52 include opposing arms 56, or side surfaces, that extend upward from the base section 54 in a generally curvilinear shape. Accordingly, an opening 57 is formed between the opposing arms 56 of the clips 52, and a trough 58, or raceway, is formed along the length of the structural tube 48 through the clips 52. Alternatively, the structural tube 48 and opposing arms 56 may also be formed from an integral extrusion as shown in FIG. 3. A trough cover 60 made from a flexible material is also included. The trough cover 60 may be flexed by spreading the side edges 62 apart to allow the trough cover 60 to be installed onto and removed from the clips 52. When installed onto the clips 52, the curvilinear shape of the opposing arms 56 and the inside surface of the trough cover 60 secure the trough cover 60 onto the structural tube 48.

Receptacle covers 64 made of a plastic material are attached at opposing ends of the structural tube 48 to the bottom side 49 of the tube 48. The receptacle covers 64 may be attached to the structural tube 48 with flexible fingers 66 that snap into slots in the structural tube 48 or by other means. At the outer end of the receptacle cover 64, a cylindrical end portion 68 is formed onto the receptacle cover 64. A slot 20 through the cylindrical end portion 68 is also provided that extends through the outer end of the receptacle cover 64 to the interior cavity 72 within the receptacle cover 64. Along the sides of the receptacle cover 64, receptacle openings 74 are provided which extend through each of the sides to the interior cavity 72. A slot 76 is also provided through the inner end of the receptacle cover 64. As shown in FIG. 3, electrical receptacles 78 are installed into the receptacle openings 74. A harness assembly 80, or electrical conduit, extends between opposing receptacle covers 64 and passes through the slots 76 through the inner ends of the receptacle covers 64. Each end of the harness 80 is then connected to the receptacles 78.

The routing of the cables 2, 4 through the connecting hubs 12 and the horizontal beams 14 is now apparent. The communication cables 2 bend from the top post 16 along an approximately right angle curve to pass to the trough 58 in the horizontal beam 14. When the communication cables 2 are required to pass from one horizontal beam 14 to another horizontal beam 14, the communication cables 2 pass out from the end of the first horizontal beam 14 and pass into a connecting hub 12. The cables 2 then bend around the bottom structural tube 28 and pass into the end of the second horizontal beam 14. Accordingly, the communication cables 2 may pass along a linear path through a connecting hub 12 between horizontal beams 14 attached to opposite sides of the connecting hub 12, or the communication cables 2 may be redirected by bending the cables 2 through the connecting hub 12 so that the cables 2 pass between adjacent horizontal beams 14 attached at right angles to each other. The communication cables 2 may exit the cable management system 10 through the open space 82 between the top of the connecting hub cover 32 and the bottom of the top cover 20 or the connecting hub top cover 33. Alternatively, the cables may be connected to communications ports 6 provided through the trough cover 60.

The electrical conduit 4 also bends from the bottom of the top post 16 along an approximately right angle curve to pass below the connecting member 36 to the receptacles 78 in the receptacle cover 64. In so doing, the electrical conduit 4 passes along the recessed area 40 of the connecting member 36. The electrical conduit 4 then passes through the slot 70 in the cylindrical end portion 68 of the receptacle cover 64 thereby passing into the interior cavity 72. The electrical cables 4 are then connected to the receptacles 78. Electrical power may now be supplied to opposite ends of the horizontal beams 14 through the harness assembly 80. Jumper cables 84 are also provided to supply electrical power across the connecting hubs 12 to the other horizontal beams 14. Accordingly, the jumper cables 84 are connected to the receptacles 78 in one horizontal beam 14 and pass into the connecting hub 12 through the slot 70 in the cylindrical end portion 68. The jumper cable 84 then bends around the bottom structural tube 28 and passes through the slot 70 in the cylindrical end portion 68 of another horizontal beam 14. The jumper cable 84 is then connected to the receptacles 78 in the other horizontal beam 14.

Some of the advantages of the cable management system 10 are now readily apparent. The cable management system 10 allows cables 2, 4 to be routed through an open office area without traditional workspace panels. The cable management system 10 also does not require channels or passageways in the floor or raised flooring systems. In contrast, the cable management system 10 uses space commonly available in the ceilings of office areas to route cables 2, 4 through the office area. Top posts 16 may then be located as desired to route the cables 2, 4 from the ceiling to the connecting hubs 12 and the horizontal beams 14.

Typically, the horizontal beams 14 may be positioned about two feet up from the floor or between 1.5 and 3.5 feet from the floor. This position provides an open, unobstructed area that improves collaboration between office workers while providing a dividing system between adjacent workspaces. The horizontal beams 14 may also be rotated around the pivot connections 46 between the horizontal beams 14 and the connecting hubs 12. This allows the position of the horizontal beams 14 to be instantly moved by hand if so desired.

The actual routing process of the communication cables 2, 4 is also easier with the cable management system 10 than with traditional systems. Accordingly, the top covers 20 from the top posts 16 and the trough covers 60 from the horizontal beams 14 may be simultaneously removed. The entire length of a communication cable 2, 4 may then be laid directly into the troughs and secured to the top structural tube 18. After the cables 2, 4 are routed to the desired routing locations by laying the cables 2, 4 into the troughs 58, the trough covers 60 and top covers 20 may be reinstalled. This process is considerably easier, faster and less expensive than processes that involve pushing or pulling cables through long, narrow passages.

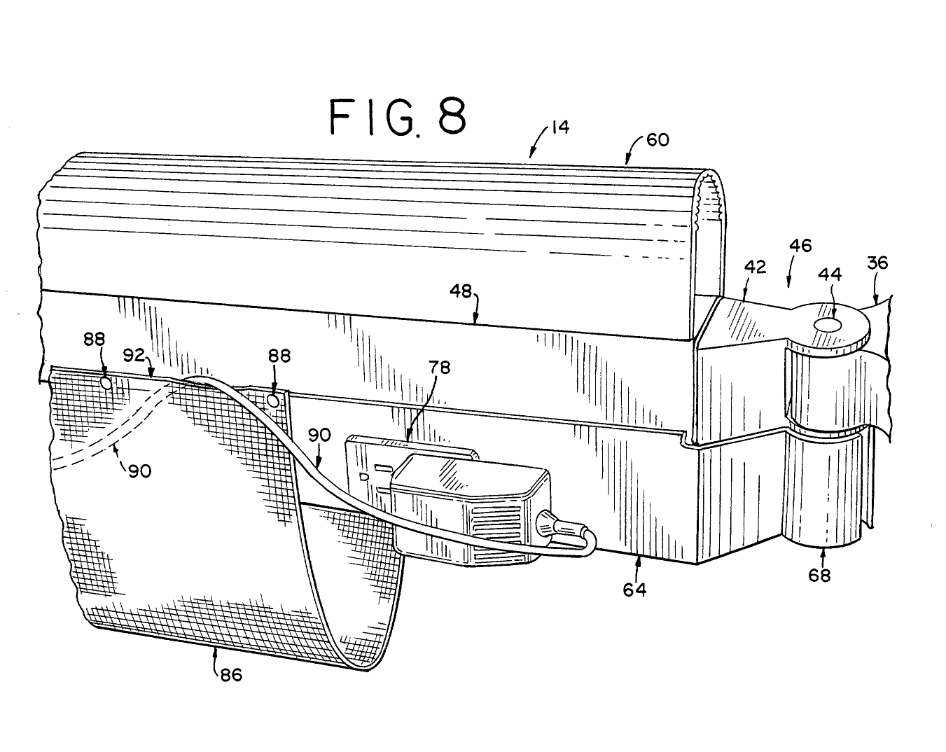

Another advantage of the cable management system 20 is that a cable management pouch 86 may be provided as shown in FIG. 8. The cable management pouch 86 may be made from a fabric material. The pouch 86 is attached to the sides of the horizontal beam 14 with buttons 88 or velcro or other similar fasteners. Excess lengths of cables 90 may then be inserted into the pouch 86 between the side edge 92 of the pouch 86 and the side of the horizontal beam 14. The cable management pouch 86 is especially useful behind a workstation where computer cables and other communication and electrical cables may be stored in the pouch 86.

While a preferred embodiment of the invention has been described, it should be understood that the invention is not so limited, and modifications may be made without departing from the invention. The scope of the invention is defined by the appended claims, and all devices or methods that come within the meaning of the claims, either literally or by equivalence, are intended to be embraced therein.

We claim:

1. A cable management system comprising a horizontal beam disposed above a floor, a first open area being formed between said horizontal beam and said floor and a second open area being formed between said horizontal beam and a ceiling; and first and second connecting hubs attached to opposite ends of said horizontal beam; wherein a cable passes from said first connecting hub through said horizontal beam to said second connecting hub.

2. The cable management system according to claim 1, wherein said horizontal beam is disposed between about 1.5 to 3.5 feet above said floor.

3. The cable management system according to claim 1, wherein said horizontal beam comprises a trough with side surfaces, an opening formed between said side surfaces, and a trough cover enclosing said opening.

4. The cable management system according to claim 3, wherein said horizontal beam further comprises a horizontal structural member, wherein said trough is formed by arms extending from said horizontal structural member, said trough cover thereby being installed over said arms.

5. The cable management system according to claim 1, wherein said horizontal beam comprises a horizontal structural member and first and second receptacles disposed at opposite ends of said horizontal structural member, a harness extending lengthwise along said horizontal structural member and being connected to both said first and second receptacles.

6. The cable management system according to claim 1, further comprising a top post attached to one of said first and second connecting hubs and extending up to a ceiling, wherein a cable passes from said ceiling through said top post to said one of said first and second connecting hubs and through said horizontal beam.

7. The cable management system according to claim 6, wherein said top post comprises a top structural member attached to said one of said first and second connecting hubs and a top cover, said cable passing between said top structural member and said top cover.

8. The cable management system according to claim 1, wherein said horizontal beam is pivotally attached at said opposite ends to said first and second connecting hubs.

9. The cable management system according to claim 8, wherein said first and second connecting hubs comprise connecting hub covers enclosing said pivotal attachments between said horizontal beam and said first and second connecting hubs, said connecting hub covers comprising slots adapted to extend said opposite ends of said horizontal beam through, wherein said first and second connecting hubs further comprise bottom structural members extending down to said floor, a base being attached to a bottom end of each of said bottom structural members and thereby supporting said horizontal beam.

10. The cable management system according to claim 1, further comprising a cable management pouch attached along a side edge to said horizontal beam, wherein an excess cable passes between said horizontal beam and said side edge.

11. The cable management system according to claim 1, wherein said horizontal beam is disposed between about 1.5 to 3.5 feet above said floor; wherein said horizontal beam comprises a trough with side surfaces, an opening formed between said side surfaces, and a trough cover enclosing said opening; and further comprising a top post attached to one of said first and second connecting hubs and extending up to a ceiling, wherein a cable passes from said ceiling through said top post to said one of said first and second connecting hubs and through said horizontal beam.

12. The cable management system according to claim 11, wherein said horizontal beam is pivotally attached at said opposite ends to said first and second connecting hubs; wherein said top post comprises a top structural member attached to said one of said first and second connecting hubs and a top cover, said cable passing between said top structural member and said top cover; and wherein said horizontal beam further comprises a horizontal structural member, wherein said trough is formed by arms extending from said horizontal structural member, said trough cover thereby being installed over said arms.

13. The cable management system according to claim 12, wherein said horizontal beam comprises first and second receptacles disposed at opposite ends of said horizontal structural member, a harness extending lengthwise along said horizontal structural member and being connected to both said first and second receptacles; wherein said first and second connecting hubs comprise connecting hub covers enclosing said pivotal attachments between said horizontal beam and said first and second connecting hubs, said connecting hub covers comprising slots adapted to extend said opposite ends of said horizontal beam through, wherein said first and second connecting hubs further comprise bottom structural members extending down to said floor, a base being attached to a bottom end of each of said bottom structural members and thereby supporting said horizontal beam; and further comprising a cable management pouch attached along a side edge to said horizontal beam, wherein an excess cable passes between said horizontal beam and said side edge.

14. A cable management system comprising a connecting hub comprising a bottom structural member extending down to a floor thereby supporting said connecting hub; a top post attached to said connecting hub and extending up to a ceiling; and a horizontal beam attached to said connecting hub and extending out from said connecting hub; wherein a cable passes from said ceiling through said top post to said connecting hub and through said horizontal beam.

15. The cable management system according to claim 14, wherein said horizontal beam is disposed between about 1.5 to 3.5 feet above said floor.

16. The cable management system according to claim 14, wherein said horizontal beam comprises a trough with side surfaces, an opening formed between said side surfaces, and a trough cover enclosing said opening.

17. The cable management system according to claim 16, wherein said horizontal beam further comprises a horizontal structural member, wherein said trough is formed by arms extending from said horizontal structural member, said trough cover thereby being installed over said arms.

18. The cable management system according to claim 14, wherein said top post comprises a top structural member attached to said connecting hub and a top cover, said cable passing between said top structural member and said top cover.

19. The cable management system according to claim 14, wherein said horizontal beam is pivotally attached to said connecting hub.

20. The cable management system according to claim 19, wherein said connecting hub comprises a connecting hub cover enclosing said pivotal attachment between said horizontal beam and said connecting hub, said connecting hub cover comprising a slot adapted to extend an end of said horizontal beam through, wherein said connecting hub further comprises a base attached to a bottom end of said bottom structural member and disposed on said floor.

21. The cable management system according to claim 14, wherein said horizontal beam is disposed between about 1.5 to 3.5 feet above said floor; wherein said top post comprises a top structural member attached to said connecting hub and a top cover, said cable passing between said top structural member and said top cover; and wherein said horizontal beam is pivotally attached to said connecting hub.

22. The cable management system according to claim 21, wherein said horizontal beam comprises a trough with side surfaces, an opening formed between said side surfaces, and a trough cover enclosing said opening; wherein said horizontal beam further comprises a horizontal structural member, wherein said trough is formed by arms extending from said horizontal structural member, said trough cover thereby being installed over said arms; and wherein said connecting hub comprises a connecting hub cover enclosing said pivotal attachment between said horizontal beam and said connecting hub, said connecting hub cover comprising a slot adapted to extend an end of said horizontal beam through, wherein said connecting hub further comprises a base attached to a bottom end of said bottom structural member and disposed on said floor.

23. A cable management system comprising a connecting hub; a first horizontal beam pivotally attached to said connecting hub; and a second horizontal beam pivotally attached to said connecting hub; wherein a cable passes from said first horizontal beam through said connecting hub to said second horizontal beam.

24. The cable management system according to claim 23, wherein said first and second horizontal beams are disposed between about 1.5 to 3.5 feet above a floor, a first open area being formed between said first and second horizontal beams and said floor and a second open area being formed between said first and second horizontal beams and a ceiling.

25. The cable management system according to claim 23, wherein said first and second horizontal beams comprise troughs with side surfaces, openings formed between said side surfaces, and trough covers enclosing said openings.

26. The cable management system according to claim 25, wherein said first and second horizontal beams further comprise horizontal structural members, wherein said troughs are formed by arms extending from said horizontal structural members, said trough covers thereby being installed over said arms.

27. The cable management system according to claim 23, wherein each of said first and second horizontal beams comprise horizontal structural members and first and second receptacles disposed at opposite ends of said horizontal structural members, a harness extending lengthwise along each of said horizontal structural members and being connected to both said first and second receptacles, and further comprising a jumper passing through said connecting hub and being connected to each of said harnesses.

28. The cable management system according to claim 23, further comprising a top post attached to said connecting hub and extending up to a ceiling, wherein a cable passes from said ceiling through said top post to said connecting hub and through said horizontal beam.

29. The cable management system according to claim 28, wherein said top post comprises a top structural member attached to said connecting hub and a top cover, said cable passing between said top structural member and said top cover.

30. The cable management system according to claim 23, wherein said connecting hub comprises a connecting hub cover enclosing said pivotal attachments between said first and second horizontal beams and said connecting hub, said connecting hub cover comprising slots adapted to extend ends of said first and second horizontal beams through, wherein said connecting hub further comprises a base attached to a bottom end of said bottom structural member and disposed on a floor.

31. The cable management system according to claim 23, further comprising a cable management pouch attached along a side edge to one of said first and second horizontal beams, wherein an excess cable passes between said one of said first and second horizontal beams and said side edge.

32. The cable management system according to claim 23, wherein said first and second horizontal beams are disposed between about 1.5 to 3.5 feet above a floor, a first open area being formed between said first and second horizontal beams and said floor and a second open area being formed between said first and second horizontal beams and a ceiling; and further comprising a top post attached to said connecting hub and extending up to said ceiling, wherein a cable passes from said ceiling through said top post to said connecting hub and through said horizontal beam.

33. The cable management system according to claim 32, wherein each of said first and second horizontal beams comprise horizontal structural members and first and second receptacles disposed at opposite ends of said horizontal structural members, a harness extending lengthwise along each of said horizontal structural members and being connected to both said first and second receptacles, and further comprising a jumper passing through said connecting hub and being connected to each of said harnesses.

34. The cable management system according to claim 33, wherein said first and second horizontal beams comprise troughs with side surfaces, openings formed between said side surfaces, and trough covers enclosing said openings; and wherein said connecting hub comprises a connecting hub cover enclosing said pivotal attachments between said first and second horizontal beams and said connecting hub, said connecting hub cover comprising slots adapted to extend ends of said first and second horizontal beams through, wherein said connecting hub further comprises a base attached to a bottom end of said bottom structural member and disposed on said floor.

35. The cable management system according to claim 34, wherein said troughs are formed by arms extending from said horizontal structural members, said trough covers thereby being installed over said arms; and wherein said top post comprises a top structural member attached to said connecting hub and a top cover, said cable passing between said top structural member and said top cover.
